(19) United States
(12) Patent Application Publication
(10) Pub. No.: US 2008/0106418 A1
(43) Pub. Date: May 8, 2008

(54) RFID tag using patch antenna designs and low cost manufacturing techniques

(75) Inventors: Michael Sloan, Ellicott City, MD (US); Hai Tran, Aldie, VA (US); Wayne E. Shanks, Baltimore, MD (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Symbol Technologies, Inc., Holtsville, NY (US)

(21) Appl. No.: 11/591,492

(22) Filed: Nov. 2, 2006

(51) Int. Cl. G08B 13/14

(52) U.S. Cl. 340/572.7

(57) ABSTRACT

Methods, systems, and apparatuses for improved tag assemblies, are described herein. In an aspect, a radio frequency identification (RFID) tag assembly includes an enclosure, a substrate, an antenna, an electrical circuit, and a plate. The substrate is coupled to an inner surface of the enclosure. The antenna is formed on a surface of the substrate. The electrical circuit is on the substrate and is electrically coupled to the antenna. The plate is attached to an outer surface of the enclosure and configured to be a ground plane for the antenna.

### BACKGROUND OF THE INVENTION

1. Field of the Invention

The invention relates to radio frequency identification (RFID) technology, and in particular, to RFID tag assemblies.

2. Background Art

Radio frequency identification (RFID) tags are electronic devices that may be affixed to items whose presence is to be detected and/or monitored. The presence of an RFID tag, and therefore the presence of the item to which the tag is affixed, may be checked and monitored wirelessly by devices known as “readers.” Readers typically have one or more antennas transmitting radio frequency signals to which tags respond. Since the reader “interrogates” RFID tags, and receives signals back from the tags in response to the interrogation, the reader is sometimes termed as “reader interrogator” or simply “interrogator”.

With the maturation of RFID technology, efficient communication between tags and interrogators has become a key enabler in supply chain management, especially in manufacturing, shipping, and retail industries, as well as in building security installations, healthcare facilities, libraries, airports, warehouses etc.

RFID tags are also used to monitor various types of large assets, such as supply trucks, often under severe environmental conditions. Moreover, tag assemblies that protect tags from environmental conditions often require expensive manufacturing techniques.

Thus what is needed is a way of protecting tags from environmental conditions, which can be manufactured inexpensively.

### BRIEF SUMMARY OF THE INVENTION

Methods, systems, and apparatuses for radio frequency identification (RFID) tag assemblies, are described herein. Tag assemblies described herein protect tags from environmental conditions. Methods for assembling tags described herein allow for low-cost manufacturing of tag assemblies.

In a first aspect, an RFID tag assembly includes an enclosure, a substrate, an antenna, an electrical circuit, and a plate. The antenna is formed on a surface of the substrate. The electrical circuit is on the substrate and is electrically coupled to the antenna. The substrate is coupled to an inner surface of the enclosure. The plate is attached to an outer surface of the enclosure and is configured to be a ground plane for the antenna.

The plate is not always required, depending at least in part on an antenna type for the antenna. In example aspects, the antenna may be a patch antenna, a dipole antenna, a dual dipole antenna, or other antenna type.

In a further aspect, the enclosure includes a first enclosure portion and a second enclosure portion that are coupled together to form a gap there between. The substrate is located in the gap.

In a further aspect, the enclosure is made of a material that is transparent to RF electromagnetic waves.

In an aspect, a method for assembling an RFID tag assembly includes positioning a substrate, which has an antenna formed on a surface, within an opening in a first surface of a first enclosure portion, attaching a second enclosure portion to the first enclosure portion to form the enclosure, and attaching a plate to an outer surface of the enclosure. An electrical circuit is on the substrate and is electrically coupled to the antenna. The substrate is enclosed within the enclosure. The plate is configured to be a ground plane for the antenna.

In a further aspect, attaching the second enclosure portion to the first enclosure portion includes welding the second enclosure portion to the first enclosure portion. In an example aspect, the welding includes performing vibration welding.

In a further aspect, attaching the plate to the enclosure includes welding the plate to the enclosure. In an example aspect, the welding includes performing ultrasonic welding.

In a further aspect, the tag assembly method also includes testing the electronic circuit.

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows an environment where RFID readers communicate with an exemplary population of RFID tags.

FIG. 2 shows a block diagram of receiver and transmitter portions of a RFID reader.

FIG. 3 shows a block diagram of an example radio frequency identification (RFID) tag.

FIGS. 4A-4C show views of a tag assembly, according to an embodiment of the present invention.

FIG. 5A shows a first enclosure portion, according to an embodiment of the present invention.

FIG. 5B shows a second enclosure portion, according to an embodiment of the present invention.

FIGS. 6A and 6B show top and side views, respectively, of a substrate, according to an embodiment of the present invention.

FIG. 7 shows an example patch antenna.

FIG. 8 shows another RFID tag antenna, according to an embodiment of the present invention.

FIG. 9 shows a flowchart providing example steps for assembling an RFID tag assembly, according to an example embodiment of the present invention

FIGS. 10 and 11A provide additional optional steps of FIG. 8, according to example embodiments of the present invention.

FIG. 11B shows a tag assembly attached to a surface, according to an embodiment of the present invention.

FIG. 12 provides an additional optional step of FIG. 8, according to an example embodiment of the present invention.

FIGS. 13A-13E show an example tag assembly, according to an embodiment of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

Methods, systems, and apparatuses for improved RFID tag assemblies are described herein. Tag assemblies described herein provide protection from environmental conditions and allow tags to be attached to electrically conductive surfaces. Methods for assembling tag assemblies described herein provide low-cost manufacturing techniques for tag assemblies.

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Furthermore, it should be understood that spatial descriptions (e.g., “above,” “below,” “up,” “down,” “top,” “bottom,” “vertical,” “horizontal,” etc.) used herein are for purposes of illustration only, and that practical implementations of the structures described herein can be spatially arranged in any orientation or manner.

### Example RFID System Embodiment

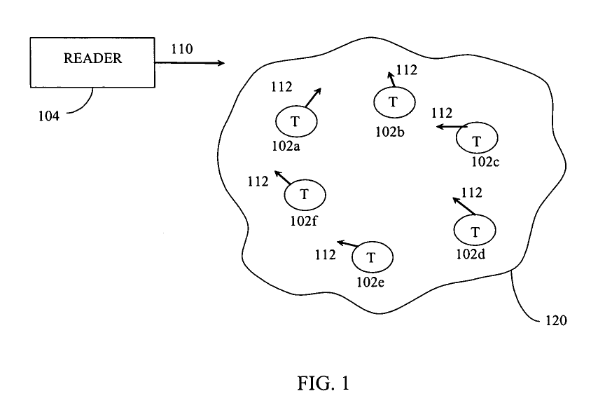

Before describing embodiments of the present invention in detail, it is helpful to describe an example RFID communications environment in which the invention may be implemented. FIG. 1 illustrates an environment 100 where RFID tag readers 104 communicate with an exemplary population 120 of RFID tags 102. As shown in FIG. 1, the population 120 of tags includes seven tags 102a-102g. A population 120 may include any number of tags 102.

Environment 100 includes one or more readers 104. A reader 104 may be requested by an external application to address the population of tags 120. Alternatively, reader 104 may have internal logic that initiates communication, or may have a trigger mechanism that an operator of reader 104 uses to initiate communication.

As shown in FIG. 1, reader 104 transmits an interrogation signal 110 having a carrier frequency to the population of tags 120. Reader 104 operates in one or more of the frequency bands allotted for this type of RF communication. For example, frequency bands of 902-928 MHz and 2400-2483.5 MHz have been defined for certain RFID applications by the Federal Communication Commission (FCC).

Various types of tags 102 may be present in tag population 120 that transmit one or more response signals 112 to an interrogating reader 104, including by alternatively reflecting and absorbing portions of signal 110 according to a time-based pattern or frequency. This technique for alternatively absorbing and reflecting signal 110 is referred to herein as backscatter modulation. Readers 104 receive and obtain data from response signals 112, such as an identification number of the responding tag 102. In the embodiments described herein, a reader may be capable of communicating with tags 102 according to any suitable communication protocol, including binary traversal protocols, slotted aloha protocols, Class 0, Class 1, EPC Gen 2, any others mentioned elsewhere herein, and future communication protocols.

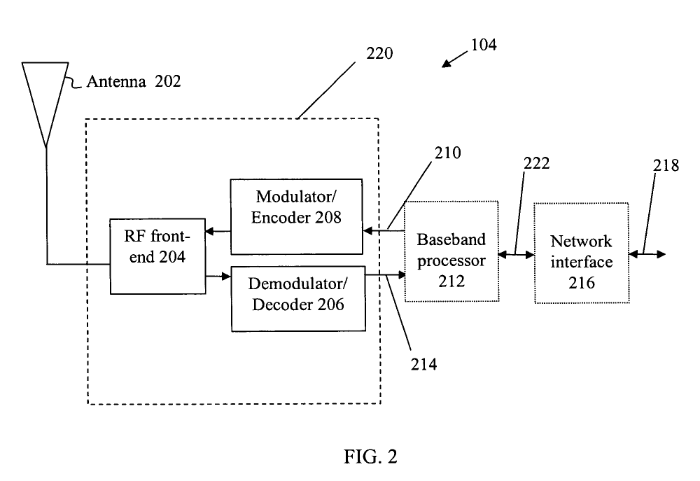

FIG. 2 shows a block diagram of an example RFID reader 104. Reader 104 includes one or more antennas 202, a receiver and transmitter portion 220 (also referred to as transceiver 220), a baseband processor 212, and a network interface 216. These components of reader 104 may include software, hardware, and/or firmware, or any combination thereof, for performing their functions.

Baseband processor 212 and network interface 216 are optionally present in reader 104. Baseband processor 212 may be present in reader 104, or may be located remote from reader 104. For example, in an embodiment, network interface 216 may be present in reader 104, to communicate between transceiver portion 220 and a remote server that includes baseband processor 212. When baseband processor 212 is present in reader 104, network interface 216 may be optionally present to communicate between baseband processor 212 and a remote server. In another embodiment, network interface 216 is not present in reader 104.

In an embodiment, reader 104 includes network interface 216 to interface reader 104 with a communications network 218. As shown in FIG. 2, baseband processor 212 and network interface 216 communicate with each other via a communication link 222. Network interface 216 is used to provide an interrogation request 210 to transceiver portion 220 (optionally through baseband processor 212), which may be received from a remote server coupled to communications network 218. Baseband processor 212 optionally processes the data of interrogation request 210 prior to being sent to transceiver portion 220. Transceiver 220 transmits the interrogation request via antenna 202.

Reader 104 has at least one antenna 202 for communicating with tags 102 and/or other readers 104. Antenna(s) 202 may be any type of reader antenna known to persons skilled in the relevant art(s), including a vertical, dipole, loop, Yagi-Uda, slot, or patch antenna type. For description of an example antenna suitable for reader 104, refer to U.S. Ser. No. 11/265,143, filed Nov. 3, 2005, titled “Low Return Loss Rugged RFID Antenna,” now pending, which is incorporated by reference herein in its entirety.

Transceiver 220 receives a tag response via antenna 202. Transceiver 220 outputs a decoded data signal 214 generated from the tag response. Network interface 216 is used to transmit decoded data signal 214 received from transceiver portion 220 (optionally through baseband processor 212) to a remote server coupled to communications network 218. Baseband processor 212 optionally processes the data of decoded data signal 214 prior to being sent over communications network 218.

In embodiments, network interface 216 enables a wired and/or wireless connection with communications network 218. For example, network interface 216 may enable a wireless local area network (WLAN) link (including a IEEE 802.11 WLAN standard link), a BLUETOOTH link, and/or other types of wireless communication links. Communications network 218 may be a local area network (LAN), a wide area network (WAN) (e.g., the Internet), and/or a personal area network (PAN).

In embodiments, a variety of mechanisms may be used to initiate an interrogation request by reader 104. For example, an interrogation request may be initiated by a remote computer system/server that communicates with reader 104 over communications network 218. Alternatively, reader 104 may include a finger-trigger mechanism, a keyboard, a graphical user interface (GUI), and/or a voice activated mechanism with which a user of reader 104 may interact to initiate an interrogation by reader 104.

In the example of FIG. 2, transceiver portion 220 includes a RF front-end 204, a demodulator/decoder 206, and a modulator/encoder 208. These components of transceiver 220 may include software, hardware, and/or firmware, or any combination thereof, for performing their functions. Example description of these components is provided as follows.

Modulator/encoder 208 receives interrogation request 210, and is coupled to an input of RF front-end 204. Modulator/encoder 208 encodes interrogation request 210 into a signal format, modulates the encoded signal, and outputs the modulated encoded interrogation signal to RF front-end 204. For example, pulse-interval encoding (PIE) may be used in a Gen 2 embodiment. Furthermore, double sideband amplitude shift keying (DSB-ASK), single sideband amplitude shift keying (SSB-ASK), or phase-reversal amplitude shift keying (PR-ASK) modulation schemes may be used in a Gen 2 embodiment. Note that in an embodiment, baseband processor 212 may alternatively perform the encoding function of modulator/encoder 208.

RF front-end 204 may include one or more antenna matching elements, amplifiers, filters, an echo-cancellation unit, a down-converter, and/or an up-converter. RF front-end 204 receives a modulated encoded interrogation signal from modulator/encoder 208, up-converts (if necessary) the interrogation signal, and transmits the interrogation signal to antenna 202 to be radiated. Furthermore, RF front-end 204 receives a tag response signal through antenna 202 and down-converts (if necessary) the response signal to a frequency range amenable to further signal processing.

Demodulator/decoder 206 is coupled to an output of RF front-end 204, receiving a modulated tag response signal from RF front-end 204. In an EPC Gen 2 protocol environment, for example, the received modulated tag response signal may have been modulated according to amplitude shift keying (ASK) or phase shift keying (PSK) modulation techniques. Demodulator/decoder 206 demodulates the tag response signal. For example, the tag response signal may include backscattered data formatted according to FM0 or Miller encoding formats in an EPC Gen 2 embodiment. Demodulator/decoder 206 outputs decoded data signal 214. Note that in an embodiment, baseband processor 212 may alternatively perform the decoding function of demodulator/decoder 206.

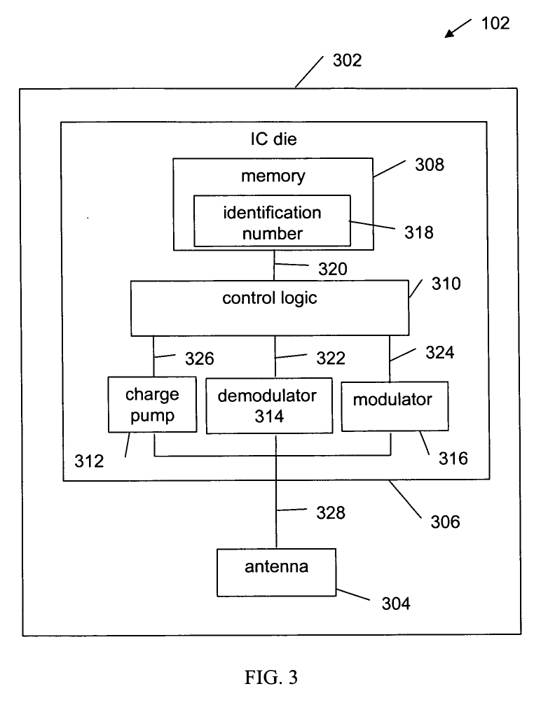

The present invention is applicable to any type of RFID tag. FIG. 3 shows a plan view of an example radio frequency identification (RFID) tag 102. Tag 102 includes a substrate 302, an antenna 304, and an integrated circuit (IC) 306. Antenna 304 is formed on a surface of substrate 302. Antenna 304 may include any number of one, two, or more separate antennas of any suitable antenna type, including dipole, loop, slot, or patch antenna type. IC 306 includes one or more integrated circuit chips/dies, and can include other electronic circuitry. IC 306 is attached to substrate 302, and is coupled to antenna 304. IC 306 may be attached to substrate 302 in a recessed and/or non-recessed location.

IC 306 controls operation of tag 102, and transmits signals to, and receives signals from RFID readers using antenna 304. In the example embodiment of FIG. 3, IC 306 includes a memory 308, a control logic 310, a charge pump 312, a demodulator 314, and a modulator 316. An input of charge pump 312, an input of demodulator 314, and an output of modulator 316 are coupled to antenna 304 by antenna signal 328. Note that in the present disclosure, the terms “lead” and “signal” may be used interchangeably to denote the connection between elements or the signal flowing on that connection.

Memory 308 is typically a non-volatile memory, but can alternatively be a volatile memory, such as a DRAM. Memory 308 stores data, including an identification number 318. Identification number 318 typically is a unique identifier (at least in a local environment) for tag 102. For instance, when tag 102 is interrogated by a reader (e.g., receives interrogation signal 110 shown in FIG. 1), tag 102 may respond with identification number 318 to identify itself. Identification number 318 may be used by a computer system to associate tag 102 with its particular associated object/item.

Demodulator 314 is coupled to antenna 304 by antenna signal 328. Demodulator 314 demodulates a radio frequency communication signal (e.g., interrogation signal 110) on antenna signal 328 received from a reader by antenna 304. Control logic 310 receives demodulated data of the radio frequency communication signal from demodulator 314 on input signal 322. Control logic 310 controls the operation of RFID tag 102, based on internal logic, the information received from demodulator 314, and the contents of memory 308. For example, control logic 310 accesses memory 308 via a bus 320 to determine whether tag 102 is to transmit a logical “1” or a logical “0” (of identification number 318) in response to a reader interrogation. Control logic 310 outputs data to be transmitted to a reader (e.g., response signal 112) onto an output signal 324. Control logic 310 may include software, firmware, and/or hardware, or any combination thereof. For example, control logic 310 may include digital circuitry, such as logic gates, and may be configured as a state machine in an embodiment.

Modulator 316 is coupled to antenna 304 by antenna signal 328, and receives output signal 324 from control logic 310. Modulator 316 modulates data of output signal 324 (e.g., one or more bits of identification number 318) onto a radio frequency signal (e.g., a carrier signal transmitted by reader 104) received via antenna 304. The modulated radio frequency signal is response signal 112, which is received by reader 104. In an embodiment, modulator 316 includes a switch, such as a single pole, single throw (SPST) switch. The switch changes the return loss of antenna 304. The return loss may be changed in any of a variety of ways. For example, the RF voltage at antenna 304 when the switch is in an “on” state may be set lower than the RF voltage at antenna 304 when the switch is in an “off” state by a predetermined percentage (e.g., 30 percent). This may be accomplished by any of a variety of methods known to persons skilled in the relevant art(s).

Modulator 316 and demodulator 314 may be referred to collectively as a “transceiver” of tag 102.

Charge pump 312 is coupled to antenna 304 by antenna signal 328. Charge pump 312 receives a radio frequency communication signal (e.g., a carrier signal transmitted by reader 104) from antenna 304, and generates a direct current (DC) voltage level that is output on a tag power signal 326. Tag power signal 326 is used to power circuits of IC die 306, including control logic 320.

In an embodiment, charge pump 312 rectifies the radio frequency communication signal of antenna signal 328 to create a voltage level. Furthermore, charge pump 312 increases the created voltage level to a level sufficient to power circuits of IC die 306. Charge pump 312 may also include a regulator to stabilize the voltage of tag power signal 326. Charge pump 312 may be configured in any suitable way known to persons skilled in the relevant art(s). For description of an example charge pump applicable to tag 102, refer to U.S. Pat. No. 6,734,797, titled “Identification Tag Utilizing Charge Pumps for Voltage Supply Generation and Data Recovery,” which is incorporated by reference herein in its entirety. Alternative circuits for generating power in a tag are also applicable to embodiments of the present invention.

It will be recognized by persons skilled in the relevant art(s) that tag 102 may include any number of modulators, demodulators, charge pumps, and antennas. Tag 102 may additionally include further elements, including an impedance matching network and/or other circuitry. Embodiments of the present invention may be implemented in tag 102, and in other types of tags.

Embodiments described herein are applicable to all forms of tags, including tag “inlays” and “labels.” A “tag inlay” or “inlay” is defined as an assembled RFID device that generally includes an integrated circuit chip (and/or other electronic circuit) and antenna formed on a substrate, and is configured to respond to interrogations. A “tag label” or “label” is generally defined as an inlay that has been attached to a pressure sensitive adhesive (PSA) construction, or has been laminated, and cut and stacked for application. Another example form of a “tag” is a tag inlay that has been attached to another surface, or between surfaces, such as paper, cardboard, etc., for attachment to an object to be tracked, such as an article of clothing, etc.

Example embodiments of the present invention are described in further detail below. Such embodiments may be implemented in the environments, readers, and tags described above, and/or in alternative environments and alternative RFID devices.

### Example Embodiments for RFID Testing Apparatuses

Methods, systems, and apparatuses for RFID tag assemblies are presented. In an embodiment, a radio frequency identification (RFID) tag assembly includes an enclosure, a substrate, an antenna, an electrical circuit, and a plate (optional). The substrate is coupled to an inner surface of the enclosure. The antenna is formed on a surface of the substrate. The electrical circuit is on the substrate and is electrically coupled to the antenna. When present, the plate is attached to an outer surface of the enclosure and is configured to be a ground plane for the antenna.

The example embodiments described herein are provided for illustrative purposes, and are not limiting. The examples described herein may be adapted to any type of RFID tag. Further structural and operational embodiments, including modifications/alterations, will become apparent to persons skilled in the relevant art(s) from the teachings herein.

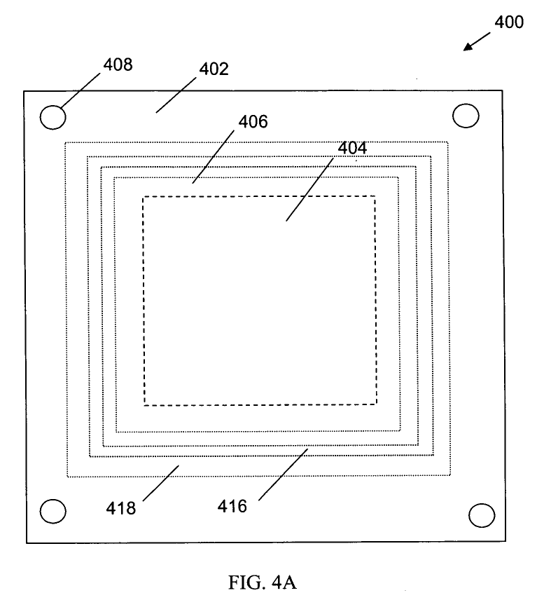

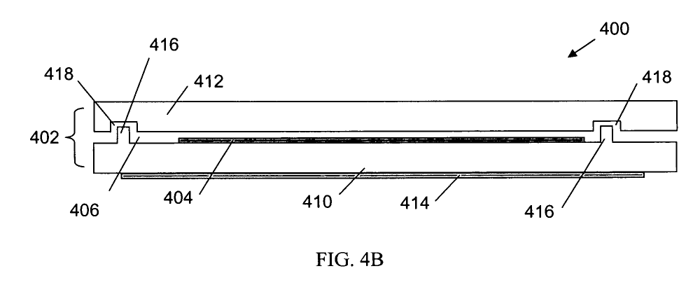

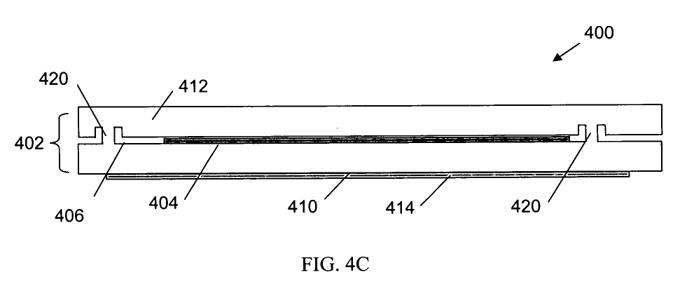

FIGS. 4A and 4B show top and side views respectively of tag assembly 400, according to an embodiment of the present invention. As shown in FIG. 4A, tag assembly 400 includes an enclosure 402, a substrate 404, and a gap 406. Enclosure 402 is shown in FIG. 4A as having a rectangular shape. In alternate embodiments, however, enclosure 402 may have other shapes such as rectangular with rounded corners, elliptical, etc. Enclosure 402 may also conform to a shape of substrate 404. Enclosure 402 is made up of materials that are transparent to RF electromagnetic waves such as a plastic material, ceramic material, a glass material, or other such material.

In an embodiment, enclosure 402 may include one or more openings 408 configured to accommodate attaching members, such as screws or bolts, that couple assembly 400 to a surface. FIG. 4A shows enclosure with four openings 408 each located at a corner of enclosure 402. However, in alternate embodiments, enclosure 402 may have any number of openings 408 located in any area of enclosure 402 as would be understood by persons skilled in the relevant art(s).

As shown in FIG. 4B, enclosure 402 has a first (bottom) enclosure portion 410 attached to a second (top) enclosure portion 412. In alternate embodiments, enclosure 402 may have more portions, as would be understood by someone skilled in the relevant art(s). In an embodiment, first enclosure portion 410 has a protruding region 416. Protruding region 416 forms a protruding rectangular ring on a top surface of first enclosure portion 410. Cavity 418 forms a recessed rectangular ring in a bottom surface of second enclosure portion 412, and is configured to accommodate protruding region 416. Protruding region 416 is configured to extend into a cavity 418 of second enclosure portion 412. Protruding region 416 and corresponding cavity 418 facilitate attaching second enclosure portion 412 to first enclosure portion 410. In alternate embodiments, first enclosure portion and second enclosure portion may be configured in other ways, as would be understood by persons skilled in the relevant art(s).

Substrate 404 is shown in FIGS. 4A and 4B as being rectangular and planar. In alternate embodiments, however, substrate 404 may have other shapes such as rectangular with rounded corners or elliptical, etc. and may be curved. Substrate 404 may be a flexible substrate such as a flexible polymer, including polyimide. In alternate embodiments, substrate 404 may be a rigid substrate including a resin-based substrate such as FR-4. An antenna is formed on a first surface of substrate 404 and an electrical circuit is located on substrate 404. These and other features of substrate 404 will be described further elsewhere herein.

Substrate 404 may be attached to the top surface of first enclosure portion 410. Gap 406 is configured to accommodate substrate 404. Gap 406 is located in a center portion of enclosure 402 such that substrate 404 is enclosed by enclosure 402. Gap 406 is shown in FIG. 4A as being rectangular in shape. In alternate embodiments, however, gap 406 may be other shapes such as rectangular with rounded corners, elliptical, etc. Gap 406 also may be shaped to conform to the shape of substrate 404. As shown in FIG. 4B, gap 406 is formed when second enclosure portion 412 is mated with first enclosure portion 410.

As shown in FIG. 4B, tag assembly 400 also includes plate 414. Plate 414 is configured to be a ground plane for the antenna formed on substrate 404. Plate 414 is made of an electrically conductive material such as aluminum or copper. Moreover, plate 414 is also configured to be electrically coupled to a surface to which tag assembly 400 is mounted. Plate 414 may be present when a ground plane is desired for an antenna of tag assembly 400, such as a patch antenna.

FIG. 4C shows tag assembly 400 after first enclosure portion 410 and second enclosure portion 412 are attached to each other, such as by welding protruding portion 416 to cavity 418. In the example of FIG. 4C, a weld 420 mates first enclosure portion 410 to second enclosure portion 412. Weld 420 may be formed by any suitable welding technique, such as those mentioned elsewhere herein.

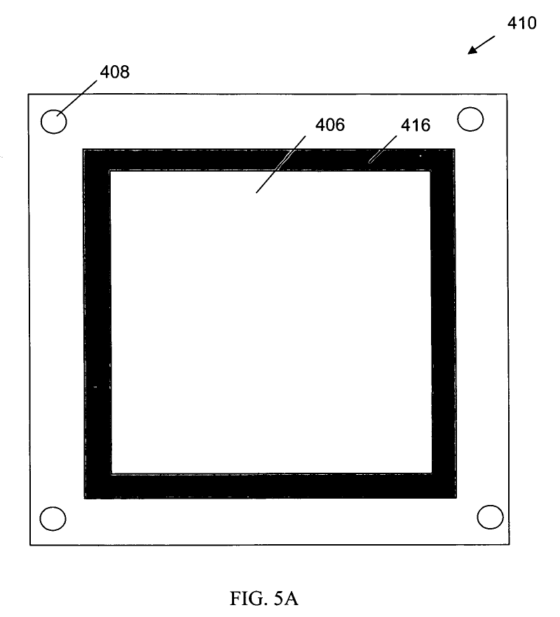

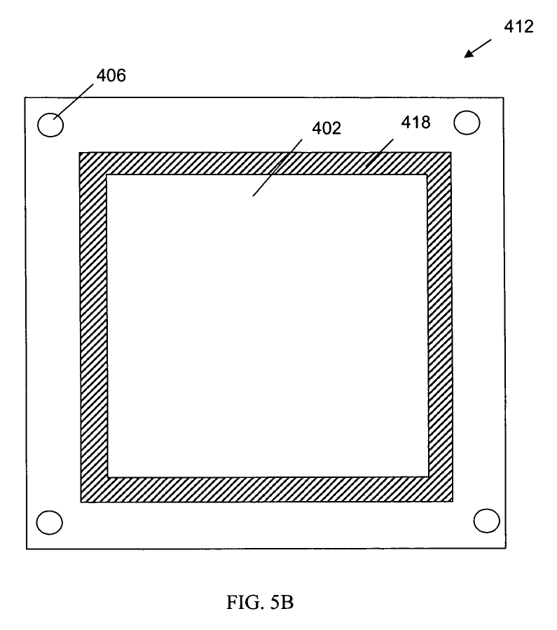

FIG. 5A shows first enclosure portion 410, according to an embodiment of the present invention. First enclosure portion 410 includes protruding region 416, gap 406, and opening 408. FIG. 5A shows protruding region 416 in a continuous rectangular ring shape in a center portion of first enclosure portion 410. In alternate embodiments, protruding region 416 may be other shapes and/or may be discontinuous.

FIG. 5B shows second enclosure potion 412, according to an embodiment of the present invention. Second enclosure portion 412 includes cavity 418 and openings 408. FIG. 5B shows cavity 418 is formed in a continuous rectangular ring shape, similar to protruding region 416 shown in FIG. 5A, in a center portion of second enclosure portion 412. In alternate embodiments, cavity 418 may be discontinuous and/or have other shapes. In embodiments, the shape of cavity 418 is at least partially determined by the shape of protruding region 416. Protruding region 416 and cavity 418 are configured to mate so that second enclosure portion 412 can be attached to first enclosure portion 410.

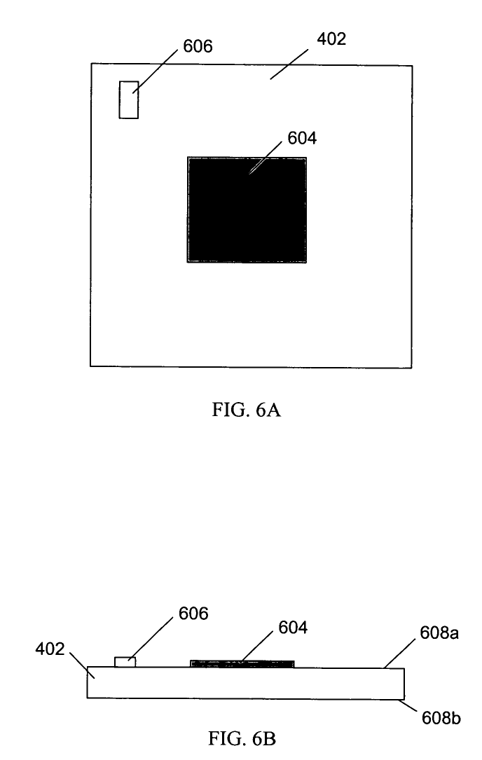

FIGS. 6A and 6B show top and side views respectively of a substrate 404, according to an embodiment of the present invention. An antenna 604 is formed on substrate 402. In an embodiment shown in FIGS. 6A and 6B, antenna 604 is a patch antenna. In alternate embodiments, antenna 604 may be other types of antennas such monopole or dipole, including dual dipole. Antenna 604 is made up of an electrically conductive material such as silver, aluminum, copper other metal, or combination of metals/alloy. Antenna 604 is shown to be substantially rectangular in shape and located in a center portion of top surface 608a. In alternate embodiments, antenna 604 may be a variety of different shapes and/or located in other areas of a surface of substrate 404, as would be understood by persons skilled in the relevant art(s). Antenna 604 radiates and receives RF electromagnetic waves such as described above for antenna 304 of tag 102 in FIG. 3.

Moreover, an electrical circuit 606 is also mounted on substrate 402. FIG. 6B shows both antenna 604 and electrical circuit 606 located on a first (top) 608a surface of substrate 404. In alternate embodiments, antenna 604 and/or electrical circuit 606 may be located on a second (bottom) surface 608b of substrate 404, or any other surface of substrate 404. Moreover, electrical circuit 606 may be embedded within a cavity in a surface of substrate 404.

Electrical circuit 606 may be electrically coupled to antenna 604 in a variety of ways such as a microstrip line and/or one or more vias. Electrical circuit may contain one or more of the elements of IC die 306 shown in example tag 102 shown in FIG. 3.

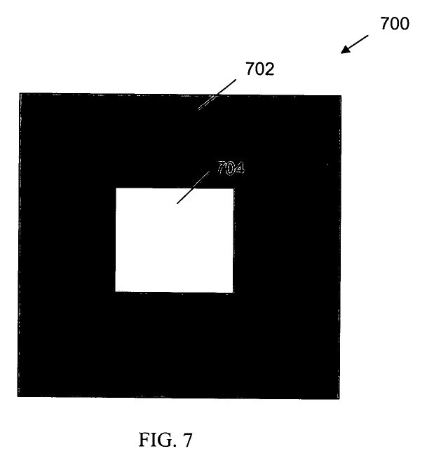

FIG. 7 shows a plan view of a substrate 700, according to an embodiment of the present invention. Substrate 700 is substantially similar to substrate 402 shown in FIGS. 6A and 6B, except that instead of having a patch of conductive material formed on a surface, substrate 700 has a layer of electrically conductive material 702 which has an opening 704. Opening 704 is shown in FIG. 7 as being substantially rectangular and located in a center portion of layer 702. In alternate embodiments, opening 704 may be a variety of other shapes and/or located in other areas of layer 702, as would be understood by persons skilled in the relevant art(s). Opening 704 is configured such that layer 702 may operate as an antenna that radiates and receives RF electromagnetic waves.

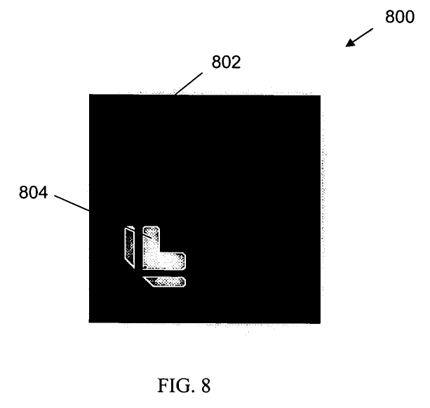

FIG. 8 shows a top view of a substrate 800, according to an embodiment of the present invention. Substrate 800 is an example embodiment of the substrate 700 shown in FIG. 7. Substrate has a layer of electrically conductive material 802 which has openings 804. Openings 804 are configured to tune or allow layer 802 to function as a dual dipole antenna. For more illustrative information on an antenna similar to that shown in FIG. 8, and other suitable antennas, see U.S. application Ser. No. 11/529,608, titled “Antenna Designs for Radio Frequency Identification (RFID) Tags,” filed Sep. 29, 2006, now pending.

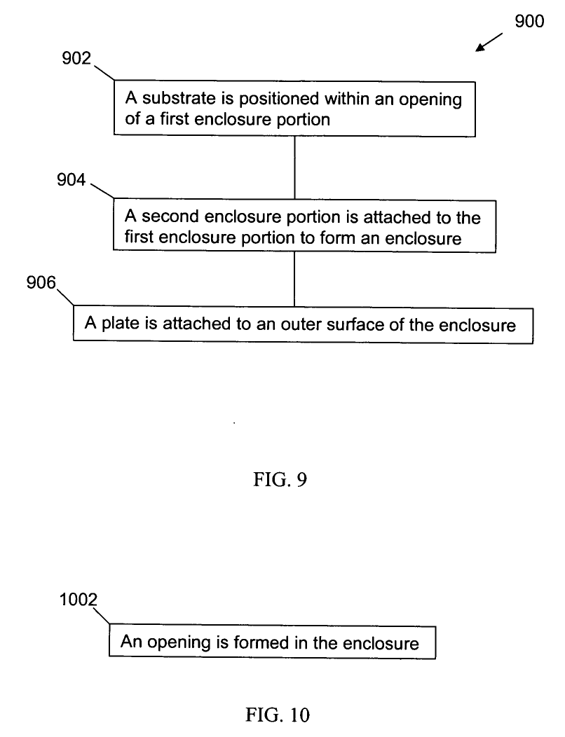

FIG. 9 shows a flowchart 900 providing example steps for assembling an RFID tag assembly, according to an embodiment of the present invention. Other structural and operational embodiments will be apparent to persons skilled in the relevant art(s) based on the following discussion. The steps shown in FIG. 9 do not necessarily have to occur in the order shown. The steps of FIG. 9 are described in detail below.

Flowchart 900 begins in step 902. In step 902, a substrate is positioned within an opening of a first enclosure portion. For example, in FIG. 4B, substrate 402 is positioned in opening 410 of first enclosure portion 410. Substrate 402 may have many different types of antennas formed on a surface, such as antennas shown in FIGS. 6A-8.

In step 904, a second enclosure portion is attached to the first enclosure portion to form an enclosure. The substrate is enclosed within the enclosure such as shown in FIG. 4B. In an embodiment, the first and second enclosure portions are welded together using vibration welding or other welding techniques, as would be understood by persons skilled in the relevant art(s). In alternate embodiments, the first and second enclosure portions may be attached in other ways, such as using an adhesive.

For example in FIG. 4C, second enclosure portion 412 is attached to first enclosure portion 410 by weld 420. In an embodiment, first enclosure portion 410 and second enclosure 412 are configured to attach to each other. For example, as shown in FIG. 4B, second enclosure portion 412 has cavity 418 that is configured to accommodate protruding region 416 of first enclosure portion 410. In alternate embodiments, the second enclosure portion may be configured to attach to the first enclosure portion in other ways as would be understood by persons skilled in the relevant art(s).

In step 906, a plate is attached to an outer surface of the enclosure. For example, in FIG. 4B, plate 414 is attached to an outer surface of the enclosure. In an embodiment, the plate is welded to the outer surface of the enclosure using ultrasonic welding or other welding techniques as would be understood by persons skilled in the relevant art(s). In alternate embodiments, the plate may be attached to the outer surface of the enclosure in other ways, such as using an adhesive or by metal plating techniques. The plate is configured to be a ground plane for the antenna. In other embodiments, the plate is not required.

FIGS. 10-12 provide example steps for flowchart 900 shown in FIG. 9. FIG. 10 shows step 1002. In step 1002, an opening is formed in the enclosure. For example, as shown in FIG. 4A, openings 408 are formed in enclosure 402. The opening is configured to accommodate an attaching member, such as a screw or a bolt, that attaches the enclosure to the surface. In further embodiments, a plurality of openings is formed in the enclosure and is configured to accommodate attaching members that attach the enclosure to the surface.

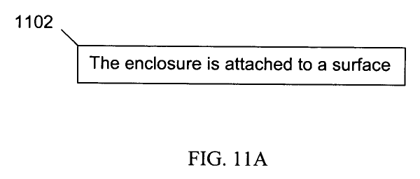

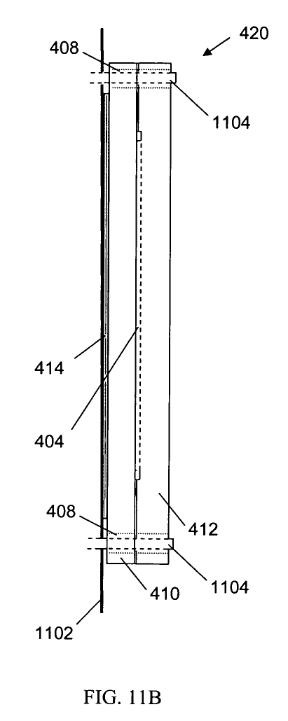

FIG. 11A shows example step 1102. In step 1102, the enclosure is attached to a surface. The plate is electrically coupled to the surface. In an embodiment, one or more attaching members may be used along with openings discussed in step 1002 to attach the enclosure to the surface. For example, in FIG. 11B, attaching members 1104 attach tag assembly 400 to a surface 1102. Surface 1102 may be an electrically conductive surface and/or may be coupled to Earth ground. In such an embodiment, plate 414 is electrically coupled to surface 1102. In alternate embodiments, the enclosure may be attached to the surface in other ways such as an electrically conductive adhesive.

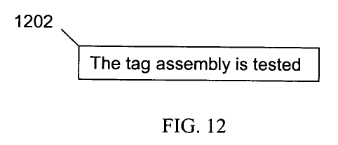

FIG. 12 shows example step 1202. In step 1202, the tag assembly is tested. The tag assembly may be tested in a variety of ways. For example, a reader may transmit an interrogation signal to be received by the antenna formed on the substrate. The electrical circuit is configured to receive the interrogation signal from the antenna and to send an identification signal to the antenna. The antenna is configured to transmit the identification signal. Thus, if the reader does not receive the identification signal from the tag assembly in response to the interrogation signal, then the tag assembly is known not to be working properly.

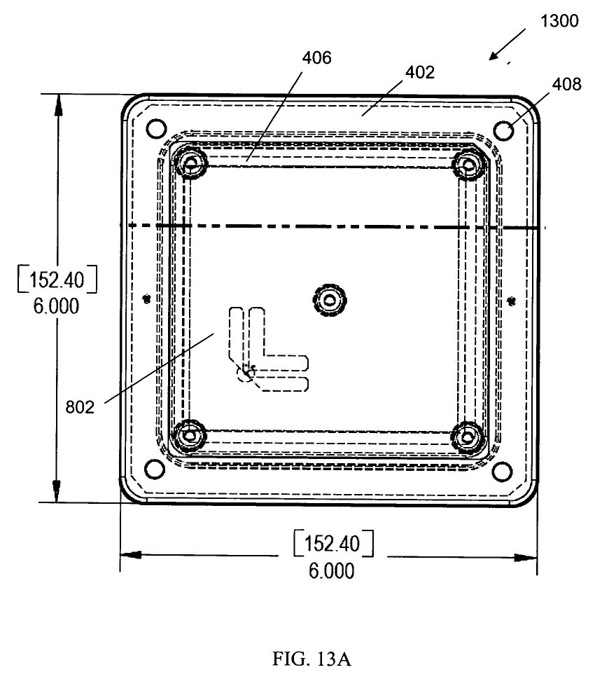

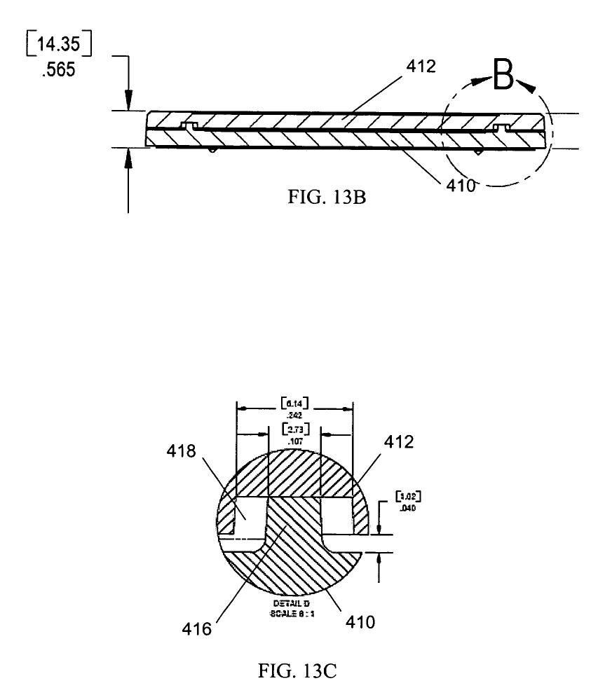

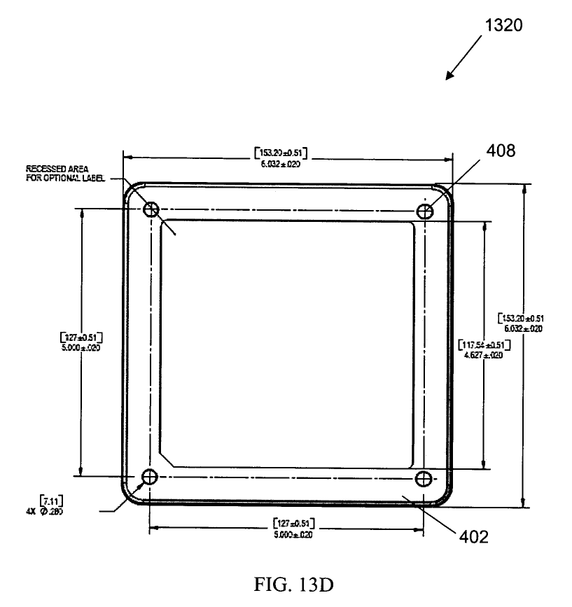

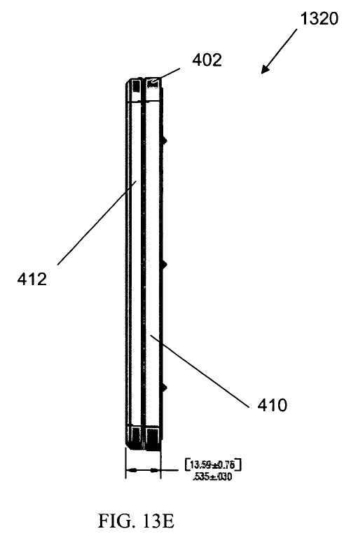

For illustrative purposes, FIGS. 13A-13E show views of example tag assemblies, according to embodiments of the present invention. In FIGS. 13A-13E, measurements are provided in inches and the bracketed measurements are in millimeters. These measurements are provided for illustrative purposes, and are not limiting. For example, such measurements may varying depending on a size and type of antenna and substrate housed by a tag assembly.

FIG. 13A shows an example tag assembly 1300 incorporating an antenna similar to antenna 802 shown in FIG. 8. Tag assembly 1300 includes enclosure 402, gap 406, and antenna 802. Tag assembly 1300 of FIG. 13A has width and length dimensions of 6.0 inches by 6.0 inches. FIG. 13B shows a side cross-sectional view of tag assembly 1300, including first enclosure portion 410 and second enclosure portion 412. In FIG. 13B, tag assembly 1300 has a thickness dimension of 0.565 inches.

FIG. 13C shows a close-up view of an interface between first enclosure portion 410 and second enclosure portion 412 of tag assembly 1300. In particular, a close up view of an example protruding portion 416 and cavity 414 are shown in FIG. 13C. In the example of FIG. 13C, cavity 414 has a width dimension of 0.242 inches and protruding portion 416 has a width dimension of 0.107 inches. A gap between the first and second enclosure portions 410 and 412 in the example of FIG. 13C has a depth of 0.040 inches. First enclosure portion 410 is attached to second enclosure portion 412 to form enclosure 402 shown in FIG. 13A.

FIG. 13D shows a plan view of enclosure 402 of a tag assembly 1320. Enclosure 402 includes openings 408. Tag assembly 1320 of FIG. 13D has width and length dimensions of 6.032±0.020 inches by 6.032±0.020 inches. FIG. 13E shows a side view of enclosure 402 including first enclosure portion 410 and second enclosure portion 412. In FIG. 13E, tag assembly 1320 has a thickness dimension of 0.535±0.030 inches.

### Example Computer System Embodiments

In this document, the terms “computer program medium” and “computer usable medium” are used to generally refer to media such as a removable storage unit, a hard disk installed in hard disk drive, and signals (i.e., electronic, electromagnetic, optical, or other types of signals capable of being received by a communications interface). These computer program products are means for providing software to a computer system. The invention, in an embodiment, is directed to such computer program products.

In an embodiment where aspects of the present invention are implemented using software, the software may be stored in a computer program product and loaded into a computer system using a removable storage drive, hard drive, or communications interface. The control logic (software), when executed by a processor, causes the processor to perform the functions of the invention as described herein.

According to an example embodiment, a tag assembly procedure and a tag testing procedure can be automated by a computer system, as further described elsewhere herein. For example, a device may execute computer-readable instructions to communicate with RFID tags, to run a test protocol, and to process test results, and/or to perform other operations described elsewhere herein.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A radio frequency identification (RFID) tag assembly comprising:
an enclosure;
a substrate coupled to an inner surface of the enclosure;
an antenna formed on the substrate;
an electrical circuit on the substrate and electrically coupled to the antenna; and
a plate attached to an outer surface of the enclosure and configured to be a ground plane.

2. The tag assembly of claim 1 wherein, the enclosure comprises a first enclosure portion and a second enclosure portion coupled together to form a gap therebetween, wherein the substrate is located in the gap.

3. The tag assembly of claim 2, wherein the first enclosure portion and the second enclosure portion are coupled by a weld.

4. The tag assembly of claim 3, wherein the weld is a vibration weld.

5. The tag assembly of claim 1, wherein the substrate is a flexible substrate.

6. The tag assembly of claim 1, wherein the antenna is a patch antenna.

7. The tag assembly of claim 1, wherein the antenna is a dipole antenna.

8. The tag assembly of claim 1, wherein the antenna is a dual dipole antenna.

9. The tag assembly of claim 1, wherein the enclosure comprises a material that is transparent to radio frequency electromagnetic waves.

10. The tag assembly of claim 9, wherein the enclosure comprises a plastic.

11. The tag assembly of claim 10, wherein the plastic is polypropylene.

12. The tag assembly of claim 1, wherein the plate comprises aluminum.

13. The tag assembly of claim 1, wherein the plate is configured to be electrically coupled to a surface of an item to which the tag assembly is mounted.

14. The tag assembly of claim 1, wherein the enclosure comprises at least one opening configured to accommodate an attaching member to attach the tag assembly to a surface.

15. The tag assembly of claim 1, wherein the plate and the enclosure are coupled by a weld.

16. The tag assembly of claim 15, where the weld is an ultrasonic weld.

17. A method for assembling a radio frequency identification (RFID) tag assembly comprising:
(1) positioning a substrate within an opening in a first surface of a first portion of an enclosure, wherein an antenna is formed on a surface of the substrate, wherein an electrical circuit is coupled to a surface of the substrate and the electrical circuit is electrically coupled to the antenna;
(2) attaching a second enclosure portion to the first enclosure portion to form the enclosure, wherein the substrate is enclosed within the enclosure; and
(3) attaching a plate to an outer surface of the enclosure, wherein the plate is configured to be a ground plane for the antenna.

18. The method of claim 17, wherein the antenna is a patch antenna, further comprising forming the patch antenna on the substrate.

19. The method of claim 17, wherein step (2) comprises:
welding the second enclosure portion to the first enclosure portion.

20. The method of claim 19, wherein step (2) comprises:
welding the second enclosure portion to the first enclosure portion using vibration welding.

21. The method of claim 17, wherein step (2) comprises:
attaching the second enclosure portion to the first enclosure portion using an adhesive.

22. The method of claim 17, wherein step (3) comprises:
welding the plate to the enclosure.

23. The method of claim 22, wherein step (3) comprises:
welding the plate to the enclosure using ultrasonic welding.

24. The method of claim 17, wherein step (3) comprises:
attaching the plate to the enclosure using an adhesive.

25. The method of claim 17, further comprising:
(4) forming at least one opening in the enclosure, wherein the opening is configured to accommodate an attaching member to attach the tag to a surface.

26. The method of claim 17, further comprising:
(4) attaching the tag assembly to a surface of an item, wherein the plate is electrically coupled to the surface of the item.

27. The method of claim 17, further comprising:
(4) testing the tag assembly.
